(19) United States
(12) Patent Application Publication
(10) Pub. No.: US 2005/0213254 A1
(43) Pub. Date: Sep. 29, 2005

(54) Ramp unit and magnetic disc apparatus

(75) Inventors: Takeshi Okutomi, Tokyo (JP); Hideyuki Miyazaki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/077,196

(22) Filed: Mar. 11, 2005

(30) Foreign Application Priority Data
Mar. 25, 2004 (JP) 2004-090674

(51) Int. Cl. G11B 5/60

(52) U.S. Cl. 360/254.8

(57) ABSTRACT

Disclosed is a ramp unit attached within a casing housing a magnetic disc, and making a magnetic head standby, the ramp unit including: a ramp main body guiding and holding the magnetic head retreated from a surface of the magnetic disc; and a sleeve member integrally provided with the ramp main body and having a tap hole to fix the ramp main body relative to the casing with screws, and further a magnetic disc apparatus using this ramp unit is disclosed.

### CROSS-REFERENCE TO THE INVENTION

This application is based upon and claims the benefit of priority from the prior Japanese Patent Application No. 2004-90674, filed on Mar. 25, 2004; the entire contents of which are incorporated herein by reference.

### BACKGROUND

1. Field of the Invention

The present invention relates to, for example, a ramp unit retreating a magnetic head at a tip portion of an arm moving on a surface of a magnetic disc, and to a magnetic disc apparatus including this ramp unit in a casing thereof.

2. Description of the Related Art

A magnetic disc apparatus is using a magnetic disc as a recording medium, performing a record and playback of information, and the magnetic disc is held and rotated by a hub of a disc motor, and thereby, the record and playback of information to/from the magnetic disc is performed.

In this magnetic disc apparatus, a magnetic head is prevented from being contacted with the magnetic disc by a cushion of air moving together with the magnetic disc. However, when the magnetic disc is start rotating from a static state, the not enough cushion of air can be obtained, and therefore, a friction between the magnetic head and a surface of the magnetic disc is occurred for a certain distance.

From these reasons, a ramp unit is used to retreat the magnetic head from the surface of the magnetic disc, while the disc drive is not in operation (for example, refer to the following Patent Document 1).

The ramp unit is resin parts molded by pouring plastic ramp unit material into a mold for injection molding, or assembling parts of a resin part and a metal sleeve. This ramp unit is fixed with a screw to a base portion such as a cover or a base from one side of either above or below.

Meanwhile, a casing to house the ramp unit together with the magnetic head and the magnetic disc, is composed of the base and the cover covering thereon, and they are assembled by inserting screws into holes provided at the respective parts, and fastening to a female screw portion provided at the other part.

Namely, to attach the ramp unit and to connect the base and the cover, it is required to prepare the separate holes respectively, and to attach with the separate screws. Therefore, it is required to prepare an attachment area and a connection area for these separately, and it inhibits a miniaturization of the apparatus or the parts, and a reduction of a number of parts.

[Patent Document 1] Japanese Patent Laid-open Application No. 2001-23325

As described above, in the conventional magnetic disc apparatus, when the parts are assembled, the ramp unit is fixed to the base with the screw at first, and then, the base portion being a built-in parts and the cover are to be fastened with screws separately. Therefore, it causes increases of a number of processes of attachment and connection thereof, and the number of parts. In addition, it is necessary to prepare the attachment area or the connection area thereof separately, and there is a problem that the miniaturization of the apparatus cannot be performed.

### SUMMARY

The present invention is made to solve these problems, and the object thereof is to provide a ramp unit and a magnetic disc apparatus contributing to a miniaturization of an apparatus as a whole and a reduction of a number of parts to be used, and enabling a reduction of cost.

A ramp unit according to an aspect of the present invention is the ramp unit attached within a casing housing a magnetic disc, and making a magnetic head standby, the ramp unit including: a ramp main body guiding and holding the magnetic head retreated from a surface of the magnetic disc; and a sleeve member integrally provided with the ramp main body and having a tap hole fixing the ramp main body relative to the casing with a screw.

Besides, a magnetic disc apparatus according to an aspect of the present invention, including: a magnetic disc; a casing housing the magnetic disc; a magnetic head moving mechanism including an arm and a magnetic head supported by the arm, and moving the magnetic head on a surface of the magnetic disc by the arm; a ramp main body guiding and supporting the magnetic head retreated from the surface of the magnetic disc by the magnetic head moving mechanism; a sleeve member integrally provided with the ramp main body, and having a tap hole to fix the ramp main body relative to the casing with the screw; and screws fastening the sleeve member and the casing together, with the tap hole of the sleeve member.

### BRIEF DESCRIPTION OF THE DRAWINGS

FIG. 1 is an exploded perspective view showing a magnetic disc apparatus according to an embodiment of the present invention.

FIG. 2 is a perspective enlarged view showing a ramp unit shown in FIG. 1.

FIG. 3 is a plan enlarged view showing the ramp unit shown in FIG. 1.

FIG. 4 is a sectional enlarged view showing a part of the magnetic disc apparatus shown in FIG. 1.

FIG. 5 is a plan view showing a sleeve member shown in FIG. 4.

FIG. 6 is a side view showing the sleeve member shown in FIG. 4.

FIG. 7 is a sectional view taken along the line A-Aa of the sleeve member shown in FIG. 5.

FIG. 8 is a sectional view taken along the line B-Ba of the sleeve member shown in FIG. 6.

### DETAILED DESCRIPTION

### Description of Embodiments

Embodiments of the present invention will be described with reference to the drawings, but these drawings are provided only for an illustrative purpose and by no means are intended to limit the present invention.

In a ramp unit according to an aspect of the present invention, a sleeve member integrally provided with a ramp main body functioning as a retreat portion of a magnetic head, has a tap hole to fix the ramp main body to a casing with a screw. The ramp main body is sandwiched between a base and a cover composing the casing from an axial direction, screws are screwed into the tap hole from the upper side of the cover and the lower side of the base, and thereby, a fixing of the ramp main body to the casing and a connection of the base and the cover composing the casing are performed at the same time. Herewith, it is not required to prepare areas for screwing screws separately to fix the ramp main body and to connect the base and the cover, and it contributes to a miniaturization of an apparatus as a whole, and a reduction of a number of parts to be used, and enables a reduction of cost.

Further, a magnetic disc apparatus according to an aspect of the present invention includes a base and a cover which can attach a sleeve member so as to be sandwiched from upper and lower sides in the axial direction, the base and the cover are separately fastened together into the tap hole of the sleeve member with screws from the respective sides, and thereby, it is enabled to reduce the screw parts and to make it thinner, in addition, to make an assembling of the casing rapid.

Here, the above-stated sleeve member may have a structure including a flange portion used for a positioning when the ramp main body is attached to the casing, together with a positioning hole provided at an upper surface of the ramp main body. Herewith, the ramp unit can be automatically disposed at a specified position on the base in the casing by using a robot arm, and so on, and thereby, an assembling efficiency of the ramp unit can be improved.

Besides, the above-described casing may include the base and the cover to attach the sleeve member so as to be sandwiched from the upper side and the lower side in the axial direction, and it may be structured by fastening the base and the cover together into the tap hole of the sleeve member with screws separately from the respective sides. Herewith, the screw parts can be reduced for the attachment of both the base and the cover of the casing relative to the ramp unit.

Further, the above-stated sleeve member may have a cylindrical shape, and include a rotation arresting portion relative to the ramp main body formed on a part of an outer peripheral surface either in flat, in concave, or in convex. Herewith, an idling of the sleeve member relative to the ramp main body can be prevented, when the screw is screwed into the tap hole of the sleeve member, and the connection between the ramp main body and the casing by screws can be ensured.

Besides, the above-stated flange portion may include a cut-out portion cutting out a part thereof to sandwich the outer peripheral surface thereof, and therefore, the cut-out surface can be utilized for a gripping, a transference and the positioning, and so on, for the attachment, of the ramp unit by the robot arm, and so on.

Namely, generally speaking, by using the sleeve member integrally provided with the ramp main body and having the rotation arresting portion, the fixture of the ramp main body to the base, and so on, and the connection of the base and the cover composing the casing are made by fastening together with the screws at the same area, and thereby, it becomes possible to miniaturize the apparatus as a whole and to reduce the number of parts to be used.

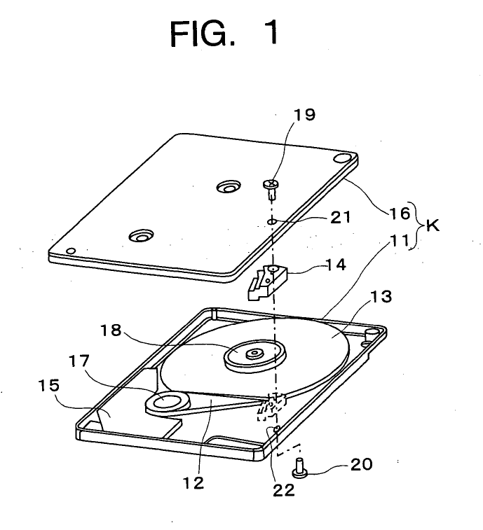

In considering the above, hereinafter, the embodiment of the present invention is described in detail with reference to drawings. FIG. 1 is a perspective view showing an exploded magnetic disc apparatus according to an embodiment of the present invention. As shown in the drawing, the magnetic disc apparatus includes, a base 11, an arm 12, a magnetic disc 13, a ramp unit 14, a top yoke 15, and a cover 16, and so on.

On the base 11, the arm 12, the magnetic disc 13, the ramp unit 14, and the top yoke 15 are provided, the cover 16 is covered from above, and thereby, the inside of the cover 16 is shut out from the outside. A casing K of this magnetic disc apparatus is composed of the base 11 and the cover 16.

The arm 12 is composing a head sub assembly, has a magnetic head performing a record and playback of data at the tip portion, and is rotatably supported on the base 11 by a bearing unit 17. This arm 12 is driven by a voice coil motor, and moves between above a surface of the magnetic disc 13 and the ramp unit 14. A magnetic head moving mechanism which moves the magnetic head supported by the arm 12 above the surface of the magnetic disc 13, is composed of these parts.

The magnetic disc 13 is sandwiched between a hub (not-shown) rotating centering around a motor shaft and a damper 18. A motor for driving the magnetic disc 13 is composed of magnets attached to the hub and coils disposed around them.

The ramp unit 14 is to be attached within the casing K housing the magnetic disc 13, and has a role as a retreating position to guide and hold the magnetic head retreated from the position on the surface of the magnetic disc 13 to the outside until an operation is started, so that the magnetic head does not to crash and scratch the surface of the magnetic disc 13 by a vibration, or the like, while the magnetic disc 13 stops the operation. When the operation is started, the ramp unit 14 also has a role to retreat the magnetic head to the position different from the surface of the magnetic disc 13, until the rotation of the magnetic disc 13 reaches a minimum speed to let the magnetic head float above the surface of the magnetic disc 13.

The top yoke 15 is a part of the voice coil motor driving a base portion of the arm 12 via the bearing unit 17. Inserting holes 21, 22 for screws 19, 20 are bored at positions facing each other of the base 11 and the cover 16. These screws 19, 20 are possible to be screwed from both above and below directions to the ramp unit 14 through the inserting holes 21, 22.

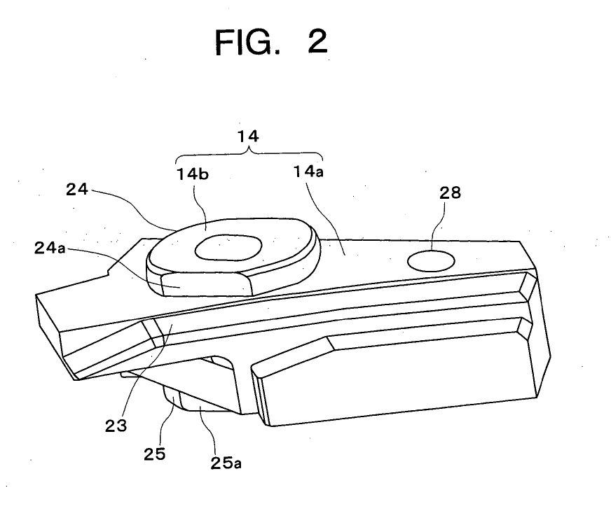

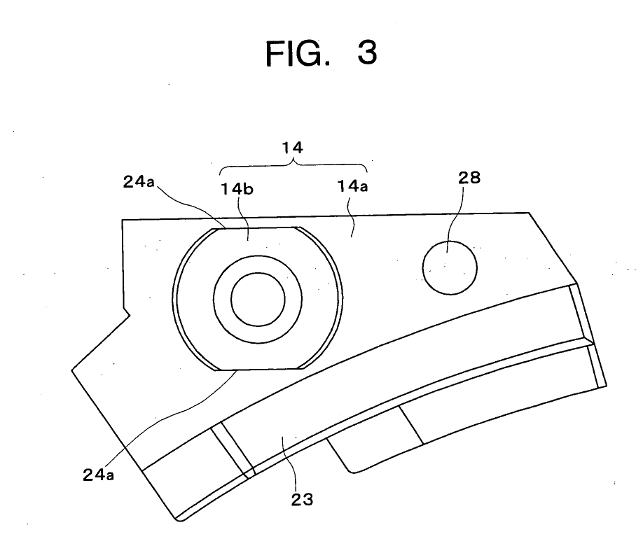

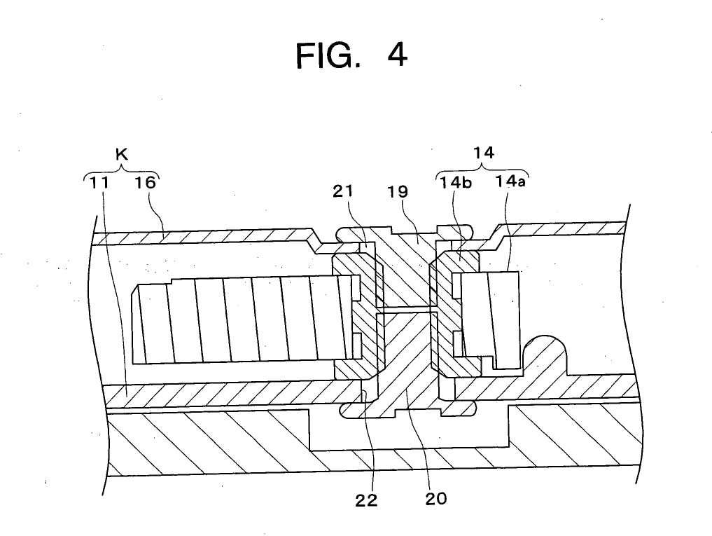

The details of the ramp unit 14 are shown in FIG. 2 and FIG. 3. FIG. 2 is a perspective view of the ramp unit 14, and FIG. 3 is a plan view of the ramp unit 14. FIG. 4 is a longitudinal sectional view of a substantial part of the ramp unit 14 in a state assembled to the casing K. This ramp unit 14 has a long pentagonal shape of a deformed type as a whole from an attached circumstance within the casing K, and so on.

The ramp unit 14 is composed of a ramp main body 14a made of a resin having a low friction coefficient and a good lubricating characteristic, for example, a liquid crystalline polymer such as a polyacetals, and a sleeve member 14b made of metal (for example, SUS, and soon) partially surrounded by the ramp main body 14a. Namely, the sleeve member 14b is integrally provided with the ramp main body 14a. The ramp main body 14a is to guide and support the magnetic head retreated from the surface of the magnetic disc 13.

For example, the sleeve member 14b is put in a mold for injection molding, and the polyacetals as resin ramp material are poured around the sleeve member 14b. Herewith, the ramp unit 14 is formed by an insert molding of the sleeve member 14b.

The ramp unit 14 is provided at a peripheral portion of the magnetic disc 13 on the base 11. On one side surface of the ramp main body 14a, an inclined guide 23 being a guide surface in an inclined state to guide a tip portion of the arm 12, is formed from an end portion at the near side of the sleeve member 14b to the other end portion. The ramp unit 14 (ramp main body 14a) is to retreat the magnetic head moved by the magnetic head moving mechanism composed of the head sub assembly, the voice coil motor, and so on, from the surface of the magnetic disc 13.

The inclined guide 23 slidably guide the tip portion of the arm 12 or a continuously provided magnetic head supporting member so as to smoothly take up and retreat the magnetic head (not-shown) from the surface of the magnetic disc 13. The inclination and the length of the inclined guide 23 are set so as to take up the magnetic head smoothly.

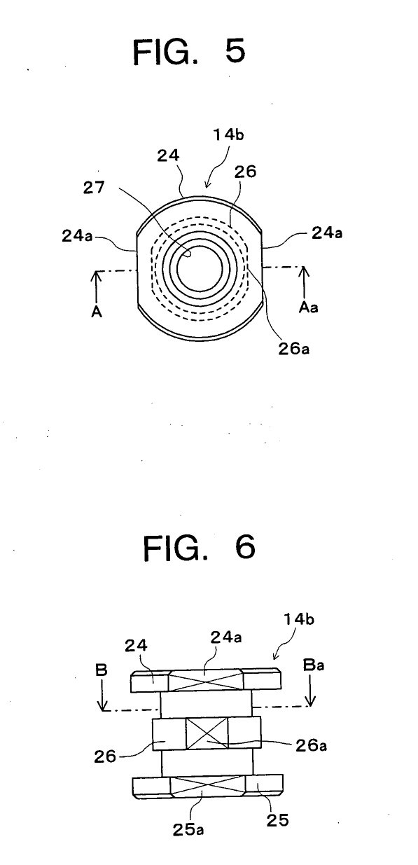

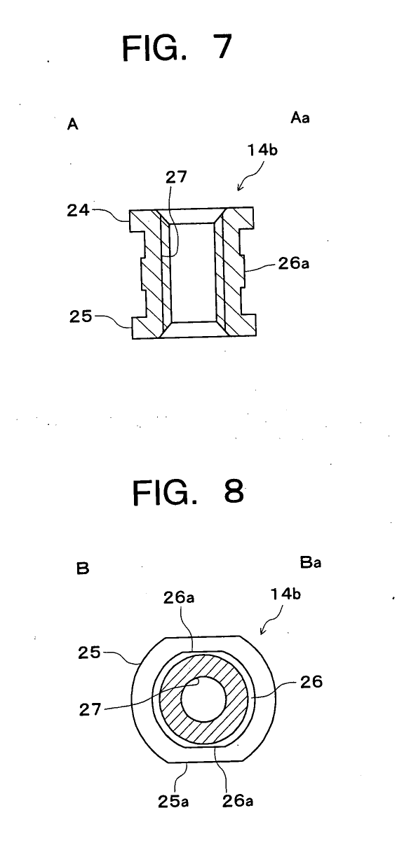

FIG. 5 and FIG. 6 are a plan view and a side view of the above-stated sleeve member 14b. Besides, FIG. 7 is a sectional view taken along a line A-Aa of the sleeve member 14b in FIG. 5, and FIG. 8 is a sectional view taken along a line B-Ba of the sleeve member 14b in FIG. 6. This sleeve member 14b has a cylindrical shape as a whole, and ring shaped flange portions (flange) 24, 25 having predetermined thicknesses are provided at outer peripheries of above and below both end portions thereof. At outer peripheries of the respective flange portions 24, 25, flat cut-out surfaces 24a, 25a for positioning, cut out substantially in parallel, are formed.

Besides, at a substantially center portion in an axial direction of the sleeve member 14b, a ring portion 26 as a rotation arresting portion is projectingly provided. At an outer periphery of the ring portion 26, a pair of flat cut-out surfaces 26a cut out substantially in parallel for rotation arresting are formed respectively. The outer periphery of the sleeve member 14b including the ring portion 26 is surrounded by the ramp main body 14a made of the polyacetals after the above-described insert molding. Therefore, the sleeve member 14b is rotation arrested relative to the ramp main body 14a by the cut-out surfaces 26a. As the rotation arresting portions, in addition to providing the flat cut-out surfaces 26a at the ring portion 26, for example, a part of the outer peripheral surface of the sleeve member 14b may be processed into a concave or convex state.

In an inner periphery of a cylindrical hole of the sleeve member 14b, a tap hole 27 for a female screw is thoroughly formed. This tap hole 27 has a tap diameter that the screws 19, 20 shown in FIG. 1 are possible to be screwed. Namely, the sleeve member 14b has the tap hole 27 to fix the ramp main body 14a relative to the casing K with screws. The screws 19, 20 fasten the sleeve member 14b and the casing K together from outside of the casing K with this tap hole 27 of the sleeve member 14b.

On the ramp main body 14a, a positioning hole 28 as shown in FIG. 2 and FIG. 3 is formed at a position departed from the sleeve member 14b. This positioning hole 28 is used when the ramp unit 14 is gripped (sandwich) to be transferred and positioned to a predetermined position within the casing K, with the cut-out surfaces 24a of the flange portion 24. Namely, these positioning hole 28 and the cut-out surfaces 24a of the flange portion 24 are used as a portion gripped by a robot arm, and so on.

The ramp unit 14 composed of the sleeve member 14b and the ramp main body 14a is assembled within the casing K as follows. At first, the above-stated ramp unit 14 is placed on the base 11. At this time, the tap hole 27 of the sleeve member 14b is accorded with the inserting hole 22 of the base 11.

Next, after the setting of various housing parts such as the magnetic disc 13 and the arm 12 is confirmed, the cover 16 is placed over the base 11. At this time, the inserting hole 21 of the cover 16 is accorded with the upper portion of the tap hole 27 of the sleeve member 14b. Herewith, the respective positions of the inserting holes 21, 22, and the tap hole 27 are accorded. The screws 19, 20 are thus respectively screwed into the tap hole 27 of the sleeve member 14b through the respective inserting holes 21, 22 from the upper side of the cover 16 and the lower side of the base 11.

Consequently, the ramp unit 14 is fixed within the casing K via the sleeve member 14b and the screws 19, 20 screwed together mutually. Namely, the sleeve member 14b is used both for fixing the ramp main body 14a into the casing K, and for the connection of the base 11 and the cover 16 composing the casing K.

Therefore, in this ramp unit 14, it is not necessary to prepare an extra area for the above-stated fixing or connection on the casing K. As a result, the miniaturization of the magnetic disc apparatus becomes possible. Further, the setting number of the screws 19, 20, the tap hole 27, and so on, can be reduced, and therefore, the workability of assembling is improved and the cost down can be realized.

As described above, according to the ramp unit 14 of this embodiment, the tap hole 27 is provided to fix the ramp main body 14a to the casing K with screws, at the ramp main body 14a functioning as the retreating portion of the magnetic head. Consequently, when the screws 19, 20 are screwed into this tap hole 27, the fixing of the ramp main body 14a to the casing K and the connection of the base 11 and the cover 16 composing the casing K can be performed at the same time.

As a result, it is not necessary to prepare areas to screw the screws 19, 20 separately for the fixing of the ramp main body 14a and the connection of the base 11 and the cover 16, and therefore, the miniaturization of the apparatus as a whole, the reduction of the number of parts to be used, and the reduction of cost are enabled.

Besides, according to the magnetic disc apparatus of this embodiment, the screws 19, 20 are screwed in the tap hole 27 of the ramp unit 14, and thereby, the sleeve member 14b and the base 11 and the cover 16 of the casing K can be fastened together. Consequently, the working efficiency of assembling of the magnetic disc apparatus can be improved.

The present invention is not limited to the specific forms described here with the illustrations, but it is to be understood that all the changes and modifications without departing from the range of the following claims are to be included therein.

1. A ramp unit attached within a casing housing a magnetic disc, and making a magnetic head standby, the ramp unit comprising:
a ramp main body guiding and holding the magnetic head retreated from a surface of the magnetic disc; and
a sleeve member integrally provided with the ramp main body and having a tap hole fixing the ramp main body relative to the casing with screws.

2. A ramp unit as set forth in claim 1,
wherein the sleeve member has a cylindrical shape, and having rotation arresting portion relative to the ramp main body, in which a part of outer peripheral surface of the rotation arresting portion is formed either in a flat surface, in a concave state, or in a convex state.

3. A ramp unit as set forth in claim 1,
wherein the ramp main body has a positioning hole at an upper surface thereof, and the sleeve member has a flange portion used for supporting when the ramp main body is attached to the casing, and the positioning hole of the ramp main body is used in the supporting.

4. A ramp unit as set forth in claim 1,
wherein the flange portion of the sleeve member has a cut-out portion to sandwich an outer peripheral surface of the flange portion of the sleeve member.

5. A magnetic disc apparatus, comprising:
a magnetic disc;
a casing housing the magnetic disc;
a magnetic head moving mechanism including an arm and a magnetic head supported by the arm, and moving the magnetic head on a surface of the magnetic disc by the arm;
a ramp main body guiding and supporting the magnetic head retreated from the surface of the magnetic disc by the magnetic head moving mechanism;
a sleeve member integrally provided with the ramp main body, and having a tap hole to fix the ramp main body relative to the casing with screws; and
screws fastening the sleeve member and the casing together with the tap hole of the sleeve member.

6. A magnetic disc apparatus as set forth in claim 5,
wherein the casing includes a base and a cover attachable to sandwich the sleeve member from upper and lower sides in an axial direction, and the base and the cover are fastened by the screws separately to the tap hole of the sleeve member.
